(19) United States
(12) Patent Application Publication
(10) Pub. No.: US 2006/0138237 A1
(43) Pub. Date: Jun. 29, 2006

(54) System and method for improved statistical bar code reading for electronic devices having a camera

(75) Inventors: Hao Wang, Beijig Feng Tai (CN); Yanming Zou, Beijig (CN); Kongqiao Wang, Beijig Tongzhou (CN)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/024,596

(22) Filed: Dec. 29, 2004

(51) Int. Cl. G06K 7/10

(52) U.S. Cl. 235/462.25; 235/462.41

(57) ABSTRACT

A system and method for statistical bar code reading for electronic devices having a camera. After a bar code is captured by the camera, a one-dimensional wave form is created based upon the captured bar code. A feature vector is created from the one-dimensional wave form, and the feature vector is compared to a plurality of reference vectors. An algorithm is used to select the reference vector that is most similar to the feature vector in order to correctly identify the captured bar code.

### FIELD OF THE INVENTION

The present invention relates generally to bar code technology. More particularly, the present invention relates to the reading and analyzing of bar codes using digital camera technology.

### BACKGROUND OF THE INVENTION

Bar code technology is used throughout the world for identifying virtually any type of product, component or service. Bar code reading is typically used to obtain an index entry for further database retrieval applications. Bar codes are used in almost every type of industry and have become ubiquitous in people's daily lives.

Traditionally, bar codes have been read using laser-based systems, where a laser beam is used to scan the bar code before a computer associates the scanned code with a particular object. The resolution of signals captured in laser-based scanners is high, with each module, the basic unit of the bar code, having tens of pixels. Traditional methods for barcode reading use a process that determines the edge location of each module, and then the feature is matched with standard code samples. Whenever using second derivative, peak location, selective sampling, or Expectation Maximization (EM) algorithm methods, the principle purpose of the system is to recover the barcode from the input signal. This requires that the resolution be high enough that one module must contain at least tens of pixels.

In recent years, cameras have been incorporated into products such as mobile telephones. As digital camera technology has advanced, it has become desirable to read individual bar codes using digital cameras. For example, an individual browsing items in a store may want to capture the bar code of a product on his or her phone so that he or she can remember the identity of the product for later investigation or purchase. Alternatively, individual businesses may want to use digital cameras for bar code scanning in addition to or instead of laser-based scanners. With different types of digital cameras becoming more popular, it is becoming more natural and feasible to perform bar code decoding through the use of a camera.

Unfortunately, however, the quality of cameras in mobile phones is currently limited, and the quality is often too low to take clear and sharp pictures of bar codes. This can lead to misread bar codes, where an incorrect item is identified, or not-read codes, where the code is not registered at all.

Compared to traditional laser scanners, the images of bar codes taken by a digital camera, such as a phone camera, have relatively low resolution and include a great deal of noise. Additionally, the size of the images is often limited and the quality of the images is poor due to the bar code in the images being blurred and deformed. These problems are often caused by too short of a distance for photo-capture and perspective. However, the bar code of interest is often high density in nature, with a requirement for identifying fine detail. Because of these issues, conventional algorithms used for bar code decoding have very poor performance in camera phone application environments.

It would therefore be desirable to have a system and method where the algorithms to be applied are compatible to the computation power and memory of a mobile phone.

### SUMMARY OF THE INVENTION

The present invention, instead of attempting to recover the features of input signals for a bar code, which may be almost impossible in some extreme cases, uses a statistical model to train the code patterns and classify the input waveforms. A list of algorithms are used for this process and can be tailored for camera phone bar code reading applications. The algorithms are not specifically designed for a single bar code standard, meaning that the scheme is capable of being extended to cover most one-dimensional bar code entities.

The present invention provides a number of significant advantages over conventional systems. In particular, the present invention provides cameras with an improved ability to recognize and analyze bar code signals, enabling cameras to be used to capture bar code signals instead of laser-based systems as necessary. The bar code reading system of the present invention can also be adaptive to most popular bar code standards. In particular, the bar code reading system of the present invention can be adaptive to variant length, code set, density, etc.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a sectional side view of a generic digital camera according to the principles of the present invention;

FIG. 2 is a perspective view of a mobile telephone that can be used in the implementation of the present invention;

FIG. 3 is a schematic representation of the telephone circuitry of the mobile telephone of FIG. 2; and

FIG. 4 is a flow diagram showing a generic process for the implementation of the present invention.

### DETAILED DESCRIPTION OF THE PREFERRED EMBODIMENTS

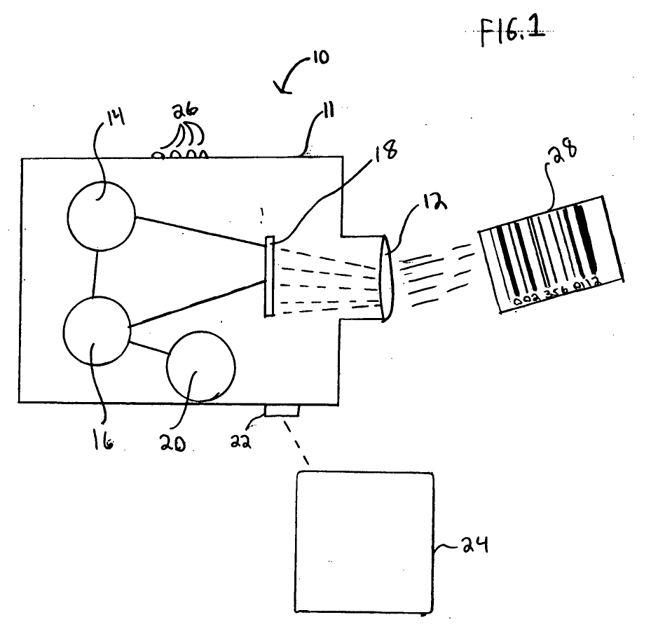

A generic digital camera constructed according to the principles of the present invention is shown at 10 in FIG. 1. The digital camera 10 can be a stand-alone device or can be incorporated into another electronic device, such as a portable telephone. The digital camera 10 includes a housing 11 which contains at least one lens 12, a primary memory unit 14, a camera processor 16, and at least one image sensor 18. The primary memory unit 14 can be used to store digital images and computer software for performing various functions in the digital camera 10, as well as to implement the present invention. A removable, secondary memory unit 20 in the form of a memory card can also be included in the digital camera to provide extra memory space. The image sensor 18 can be a charge coupled device (CCD), a complementary metal oxide semiconductor (CMOS), or another system.

When a digital picture of a bar code 28 is taken, the at least one lens 12 focuses the image onto the at least one image sensor 18 which records light electronically. The camera processor 16 then breaks this electronic information down into digital data which can be stored on the primary memory unit 14 and/or the secondary memory unit 20. The digital camera 10 also includes a data communication port 22 to enable the transmission of digital images from the digital camera 10 to a remote terminal such as a personal computer 24. The data communication can be in either wired or wireless form and can be configured for USB, Bluetooth, infrared or other connections. The digital camera 10 also includes one or more input buttons 26 for entering information and/or taking a picture, although input buttons 26 could also be remote from the digital camera 10.

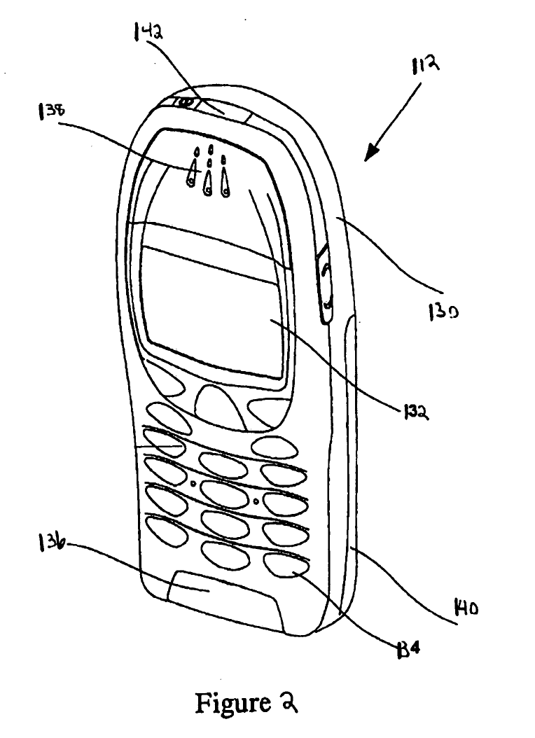

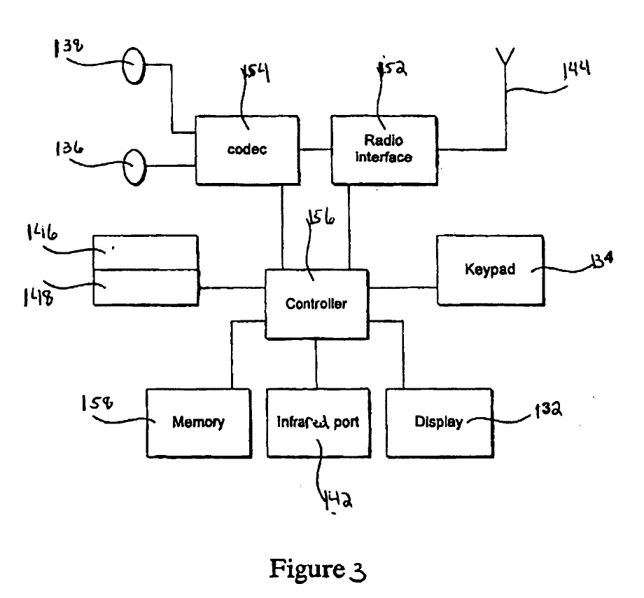

FIGS. 2 and 3 show one representative mobile telephone 112 upon which the present invention may be implemented. However, it is important to note that the present invention is not limited to any type of electronic device and could be incorporated into devices such as personal digital assistants, personal computers 24, and other devices. It should be understood that the present invention could be incorporated on a wide variety of mobile telephones 112. The mobile telephone 112 of FIGS. 2 and 3 includes a housing 130, a display 132 in the form of a liquid crystal display, a keypad 134, a microphone 136, an ear-piece 138, a battery 140, an infrared port 142, an antenna 144, a smart card 146 in the form of a universal integrated circuit card (UICC) according to one embodiment of the invention, a card reader 148, radio interface circuitry 152, codec circuitry 154, a controller 156 and a memory 158. It should be noted that the controller 156 can be the same unit or a different unit than the camera processor 16. Individual circuits and elements are all of a type well known in the art, for example in the Nokia range of mobile telephones.

According to the principles of the present invention, a statistical approach is used to correctly identify and recognize particular bar codes that are read by the digital camera 10. Conventional systems traditionally have relied upon the recovery of the features of input signals, which can be extraordinarily difficult in some extreme cases. The present invention, on the other hand, involves the use of a statistical model in order to train the code patterns and classify the input waveforms.

The present invention uses a set of algorithms, such as wavelet-based barcode location algorithms, knowledge-based character segmentation algorithms, and training methods for deformable patterns, as well as classification systems, to decode bar codes from low-quality images. The particular algorithms to be used can be tailored for camera phone bar code reading applications or other device-specific camera applications. The algorithms used, in one embodiment of the present invention, are not designed specifically for a single, specific bar code standard. In this embodiment, the present invention is capable of being used to cover most one-dimensional bar code entities.

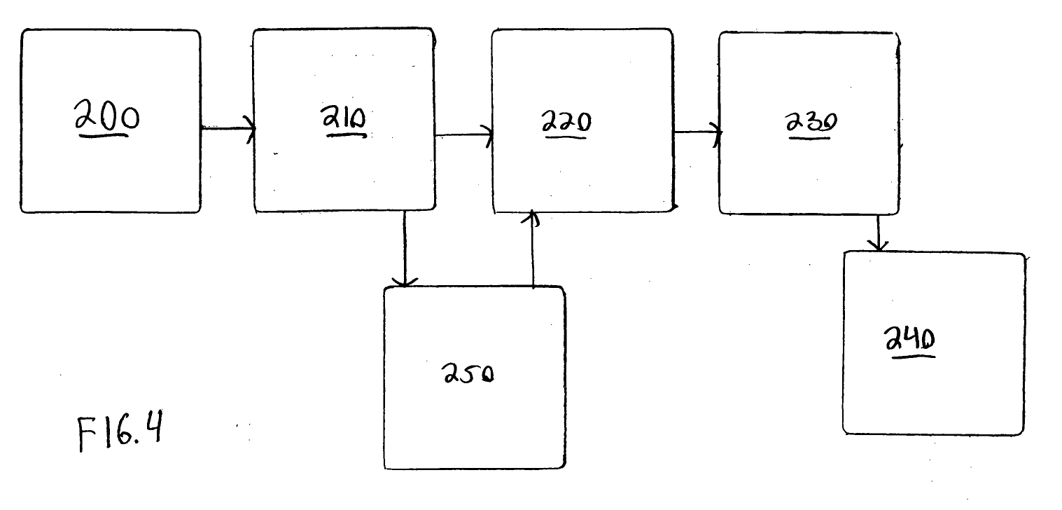

The present invention can be incorporated into a computer software product that is stored in the primary memory unit 14 or other memory system of the electronic device at issue. An implementation of the present invention is shown generally in FIG. 4. The present generally involves two principle functions: off-line training and on-line recognition. The implementation shown in FIG. 4 includes an off-line training portion 300, an on-line recognition portion 310, and a shared portion 320, whose functions are used in both on-line recognition and off-line training

At step 200, a bar code image is input as a result of a digital photograph being taken. At step 210, the bar code area is located by the system. At this step, the actual bar code is taken away from the background of the captured image. Character segmentation occurs at step 220. Character segmentation involves the dividing of the bar code into a set of characters. The segmentation is processed based upon definitions within the code standards and is referred to as “knowledge-based segmentation.” At this segmentation step, the two-dimensional bar code is converted into a one-dimensional wave form, wherein a point in the waveform corresponds to a vertical line in the original bar code. The value for the point can be considered as the sum of the brightness of all of the points on the straight line. In other words, if a point in the waveform corresponds to at least a portion of a bar, its value is low. If the point corresponds to a space between bars, its value is high.

At step 230, the wave form is converted into a feature vector for recognition. This step is referred to as “feature extraction.” To accomplish this task, a feature extraction matrix 250 is used to multiply the one-dimensional waveform and then obtain the final feature vector. The final feature vector is used for statistical recognition at step 240, which achieves the final decoding result at step 270. At this step, a class of reference vectors 260 are compared to the input vector for similarities. The most similar of the class of reference vectors 260 is used to achieve the decoding result. This method is also referred to as the “nearest neighborhood classifier.”

The off-line training portion 300 involves the steps of collecting a plurality of sample bar codes at step 280 and, at step 290, using “statistical training” in order to obtain the best possible feature extraction matrix 250 and class of reference vectors 260 for the on-line recognition process.

A wide variety of statistical methods can be used for successfully analyzing a bar code image that is captured by a digital camera 10. For example, a linear discriminant analysis (LDA), is a method of finding a linear combination of variables, and is useful in discriminating cases in two or more predefined groups. Cases are attributed to the group for which the classification function provides the highest value, or to the group whose centroid is the nearest. Similarly, generalized learning vector quantization (GLVQ) is method of finding a set of optimized reference vectors to represent these groups. Other recognition systems can also be used.

The present invention can be used for a variety of purposes. For example, the present invention can be used to accurately scan the bar code of a product by a camera phone and decode the bar code as an index. This information can be used by a user to later retrieve information about the product. For example, a user could scan the bar code of a product in a department store, and then use a public or private product database to later obtain information about the same product, including pricing information, product specifications, and other information.

The invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein and in the claims is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of reading a bar code, comprising:
capturing an image of the bar code using a camera;
creating a one-dimensional wave form based upon the captured bar code;
creating a feature vector from the one-dimensional wave form;
comparing the feature vector to a plurality of reference vectors; and
using an algorithm to select the reference vector that is most similar to the feature vector to correctly identify the captured bar code.

2. The method of claim 1, wherein the plurality of reference vectors are stored within the camera.

3. The method of claim 1, wherein the algorithm comprises a knowledge-based character segmentation algorithm.

4. The method of claim 1, wherein the algorithm comprises a wavelet-based bar code location algorithm.

5. The method of claim 1, wherein the algorithm comprises a generalized learning vector quantization.

6. The method of claim 1, wherein the algorithm comprises a linear discriminant analysis.

7. The method of claim 1, further comprising, before creating the one-dimensional wave form, separating the bar code from the rest of the captured image.

8. The method of claim 1, further comprising adding the feature vector to the plurality of reference vectors for subsequent use.

9. A computer program product for reading a bar code, comprising:
computer code for capturing an image of the bar code using a camera;
computer code for creating a one-dimensional wave form based upon the captured bar code;
computer code for creating a feature vector from the one-dimensional wave form;
computer code for comparing the feature vector to a plurality of reference vectors; and
computer code for using an algorithm to select the reference vector that is most similar to the feature vector to correctly identify the captured bar code.

10. The computer program product of claim 9, wherein the plurality of reference vectors are stored within the camera.

11. The computer program product of claim 9, wherein the algorithm comprises a knowledge-based character segmentation algorithm.

12. The computer program product of claim 9, wherein the algorithm comprises a wavelet-based bar code location algorithm.

13. The computer program product of claim 9, wherein the algorithm comprises a generalized learning vector quantization.

14. The computer program product of claim 9, wherein the algorithm comprises a linear discriminant analysis.

15. The computer program product of claim 9, further comprising computer code for, before creating the one-dimensional wave form, separating the bar code from the rest of the captured image.

16. The computer program product of claim 9, further comprising computer code for adding the feature vector to the plurality of reference vectors for subsequent use.

17. An electronic device for reading a bar code, comprising:
a housing;
a lens positioned within the housing for focusing an image;
a sensor unit receiving the image focused by the lens;
a processor operatively connected to the sensor unit; and
a memory unit operatively connected to the processor, the memory unit including:
computer code for capturing an image of the bar code;
computer code for creating a one-dimensional wave form based upon the captured bar code;
computer code for creating a feature vector from the one-dimensional wave form;
computer code for comparing the feature vector to a plurality of reference vectors; and
computer code for using an algorithm to select the reference vector that is most similar to the feature vector to correctly identify the captured bar code.

18. The electronic device of claim 17, wherein the algorithm comprises a knowledge-based character segmentation algorithm.

19. The electronic device of claim 17, wherein the algorithm comprises a wavelet-based bar code location algorithm.

20. The electronic device of claim 17, wherein the algorithm comprises a generalized learning vector quantization.

21. The electronic device of claim 17, wherein the algorithm comprises a linear discriminant analysis.

22. The electronic device of claim 17, further comprising computer code for, before creating the one-dimensional wave form, separating the bar code from the rest of the captured image.

23. The electronic device of claim 17, wherein the memory unit further comprises computer code for, adding the feature vector to the plurality of reference vectors for subsequent use.

24. A module for reading a bar code, comprising:
a lens for focusing an image;
a sensor unit receiving the image focused by the lens; and
a memory unit operatively connected to the sensor unit, the memory unit including:
computer code for capturing an image of the bar code;
computer code for creating a one-dimensional wave form based upon the captured bar code;
computer code for creating a feature vector from the one-dimensional wave form;
computer code for comparing the feature vector to a plurality of reference vectors; and
computer code for using an algorithm to select the reference vector that is most similar to the feature vector to correctly identify the captured bar code.

25. The module of claim 24, wherein the algorithm comprises a knowledge-based character segmentation algorithm.

26. The module of claim 24, wherein the algorithm comprises a wavelet-based bar code location algorithm.

27. The module of claim 24, wherein the algorithm comprises a generalized learning vector quantization.

28. The module of claim 24, wherein the algorithm comprises a linear discriminant analysis.

29. The module of claim 24, further comprising computer code for, before creating the one-dimensional wave form, separating the bar code from the rest of the captured image.

30. The module of claim 24, wherein the memory unit further comprises computer code for adding the feature vector to the plurality of reference vectors for subsequent use.
